(19) United States
(12) Patent Application Publication
(10) Pub. No.: US 2025/0288888 A1
(43) Pub. Date: Sep. 18, 2025

(54) METHOD FOR REAL-TIME INTERACTIVE DANCE EDUCATION USING AVATAR AND APPARATUS THEREFOR

(71) Applicant: ELECTRONICS AND TELECOMMUNICATIONS RESEARCH INSTITUTE, Daejeon (KR)

(72) Inventors: Ho-Jin LEE, Daejeon (KR); Jun-Suk LEE, Daejeon (KR); Jong-Sung KIM, Daejeon (KR); Seong-Won RYU, Daejeon (KR)

(73) Assignee: ELECTRONICS AND TELECOMMUNICATIONS RESEARCH INSTITUTE, Daejeon (KR)

(21) Appl. No.: 18/931,473

(22) Filed: Oct. 30, 2024

(30) Foreign Application Priority Data
Mar. 13, 2024 (KR) 10-2024-0035247

(51) Int. Cl. A63B 71/06; A63B 24/00; G06T 13/40; G06V 20/40; G06V 40/10

(52) U.S. Cl. CPC A63B 71/0622; A63B 24/0006; A63B 71/0669; G06T 13/40; G06V 20/46; G06V 40/10; A63B 2071/0625; A63B 2071/0636; A63B 2071/0638; A63B 2071/0655; A63B 2220/05; A63B 2244/22

(57) ABSTRACT

Disclosed herein are a method for real-time interactive dance education using an avatar and an apparatus therefor. In the method, the apparatus extracts a learner pose and an instructor pose from a dance video containing multiple dance learners and an instructional dance video, respectively, renders an avatar dance video based on the extracted pose of a main learner among the multiple dance learners, generates real-time multimodal dance education feedback for the main learner based on an error between the learner pose and the instructor pose, and provides the main learner with the real-time multimodal dance education feedback synchronized to the avatar dance video.

### CROSS REFERENCE TO RELATED APPLICATION

This application claims the benefit of Korean Patent Application No. 10-2024-0035247, filed Mar. 13, 2024, which is hereby incorporated by reference in its entirety into this application.

### BACKGROUND OF THE INVENTION

### 1. Technical Field

The present disclosure relates generally to technology for real-time interactive dance education using avatars, and more precisely to technology capable of providing feedback for interactive dance education in real time by utilizing computational techniques for simultaneously extracting a plurality of multi-dimensional poses and for rendering of transformed avatars from such poses.

### 2. Description of the Related Art

Dance is non-verbal communication language that represents aesthetic emotions based on movements or body motions, and it also refers to physical expression activities using spatiotemporal expressive elements (rhythm, beats, spaces like concert rooms or dance stages, etc.). Dance is already treated as an important feature in various performing art fields (traditional dancing, eurhythmics, musicals, etc.), and particularly, continuous attempts to use a human body to convey rich and complicated emotions and feelings that are difficult to articulate have been made through the professional field of choreography. Among such attempts, the K-dance genre, which expresses a certain mood in the form of an individual dance or group dance using K-pop music, has also been globally trendy among the Generation-Z, who are accustomed to using the Internet and smartphones.

Meanwhile, most offline academies that specialize in K-dance education are usually located in major cities, making it difficult to meet the widespread demand for the K-dance. Consequently, choreography academies or individual choreographers typically provide a variety of K-dance videos via online media platforms such as YouTube, allowing K-dance students or novice dancers to use the online videos for learning.

However, in the case of online video training, it is difficult to provide real-time feedback, which results in the reduced effectiveness of learning. In addition, the accessibility on these kinds of media is also limited in general, due to the psychological burden of using video information of actual people.

### DOCUMENTS OF RELATED ART

(Patent Document 1) Korean Patent Application Publication No. 10-2020-0011779, published on Feb. 4, 2020 and titled “Method and apparatus for providing dance game based on recognition of user's motion”.

### SUMMARY OF THE INVENTION

An object of the present disclosure is to provide dance education technology that allows an instructor who aims to teach dances to reflect dynamic changes of body parts required for dance learning in real time through an avatar in consideration of the temporal aspect of a dance.

Another object of the present disclosure is to provide a dance education system based on multimodal interaction that encompasses vision and multiple sensations through an education system using avatars.

A further object of the present disclosure is to provide a visual display configured with a main character and background characters by rendering a main learner and surrounding learners as avatars.

In order to accomplish the above objects, a method for real-time interactive dance education, performed by an apparatus for real-time interactive dance education, according to the present disclosure includes extracting a learner pose and an instructor pose from a dance video containing multiple dance learners and an instructional dance video, respectively, rendering an avatar dance video based on the extracted pose of a main learner among the multiple dance learners, generating real time multimodal dance education feedback for the main learner based on an error between the learner pose and the instructor pose, and providing the multimodal dance education feedback and the avatar dance video to the main learner in real time.

Here, the learner pose and the instructor pose may correspond to time-series data extracted in real time in a form of 2D and 3D skeleton data.

Here, generating the multimodal dance education feedback may include quantifying the error into a practical score numerically applicable to dance education, extracting educational information related to each body part, time, and physical quantity by inputting the learner pose and the instructor pose to a pretrained data-driven dance model, and generating the multimodal dance education feedback capable of being output through a multimodal display using the practical score and the educational information.

Here, the multimodal dance education feedback may include visual expression, auditory expression, and haptic expression.

Here, the avatar dance video may include a main character avatar corresponding to the main learner, backup dancer avatars corresponding to surrounding learners that remain after excluding the main learner from the multiple dance learners, and a background environment.

Here, rendering the avatar dance video may include visually rendering the main learner as the main character avatar after extracting the main learner from the dance video, visually rendering the remaining surrounding learners as the backup dancer avatars after extracting the remaining surrounding learners from the dance video, and visually rendering the background environment.

Here, visually rendering the main learner may comprise extracting a dance learner located in a center in a frame of the dance video, among the multiple dance learners, as the main learner.

Here, the instructional dance video may correspond to a dance video of a professional dancer for a dance section identical to the dance video.

Here, the avatar dance video may be generated in a 2D or 3D form.

Also, an apparatus for real-time interactive dance education according to an embodiment of the present disclosure includes a processor for extracting a learner pose and an instructor pose from a dance video containing multiple dance learners and an instructional dance video, respectively, rendering an avatar dance video based on the extracted pose of a main learner among the multiple dance learners, generating real time multimodal dance education feedback for the main learner based on an error between the learner pose and the instructor pose, and providing the multimodal dance education feedback and the avatar dance video to the main learner in real time; and memory for storing the dance video and the instructional dance video.

Here, the learner pose and the instructor pose may correspond to time-series data extracted in real time in a form of 2D and 3D skeleton data.

Here, the processor may quantify the error into a practical score numerically applicable to dance education, extract educational information related to each body part, time, and physical quantity by inputting the learner pose and the instructor pose to a pretrained data-driven dance model, and generate the multimodal dance education feedback capable of being output through a multimodal display using the practical score and the educational information.

Here, the multimodal dance education feedback may include visual expression, auditory expression, and haptic expression.

Here, the avatar dance video may include a main character avatar corresponding to the main learner, backup dancer avatars corresponding to surrounding learners that remain after excluding the main learner from the multiple dance learners, and a background environment.

Here, the processor may visually render the main learner as the main character avatar after extracting the main learner from the dance video, visually render the remaining surrounding learners as the backup dancer avatars after extracting the remaining surrounding learners from the dance video, and visually render the background environment.

Here, the processor may extract a dance learner located in a center in a frame of the dance video, among the multiple dance learners, as the main learner.

Here, the instructional dance video may correspond to a dance video of a professional dancer for a dance section identical to the dance video.

Here, the avatar dance video may be generated in a 2D or 3D form.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a real-time interactive dance education system using an avatar according to an embodiment of the present disclosure;

FIG. 2 a flowchart illustrating a method for real-time interactive dance education using an avatar according to an embodiment of the present disclosure;

FIGS. 3 to 5 are views illustrating examples of the detailed configuration of an apparatus for real-time interactive dance education using an avatar according to the present disclosure; and

FIG. 6 is a block diagram illustrating an apparatus for real-time interactive dance education using an avatar according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

The present disclosure intends to propose a real-time interactive dance learning system with bidirectional interactivity without limitation as to a space. The proposed system aims to reduce mental distance between real and virtual presences by delivering information about human body movements, called body motion, which is the most important part of dance expression, in real time.

K-dance becomes a global trend among young people because of the simplicity and visibility thereof, which come from relatively simple body movements and impressive group dances performed in unison, and the present disclosure intends to extract body motion in real time in consideration of the simplicity and the visibility and to express the motion in a form that is easy to visualize, such as a 3D avatar.

Specifically, in the present disclosure, a real-time interactive dance education system that includes a variety of technological items including multi-dimensional pose extraction, 3D avatar transformation, and educational feedback computation, applicable to hyper-realistic immersive content in virtual reality (VR), augmented reality (AR), and extended reality (XR) is described. The real-time interactive dance education system extracts pose (skeleton) and movement (motion) information of multiple performers (dancers) from camera images, in which the multiple performers participate, transforms extracted poses into visually rendered 3D avatars, and provides the resulted video with transformed avatars. More specifically, the present disclosure contains detailed technical explanations to implement each item, such as simultaneously extracting 2D and 3D multi-joint multi-degree-of-freedom (multi-DoF) motions of performers and transforming the motions into avatars that are suitable for dance representation and training.

Hereinafter, a preferred embodiment of the present disclosure will be described in detail with reference to the accompanying drawings.

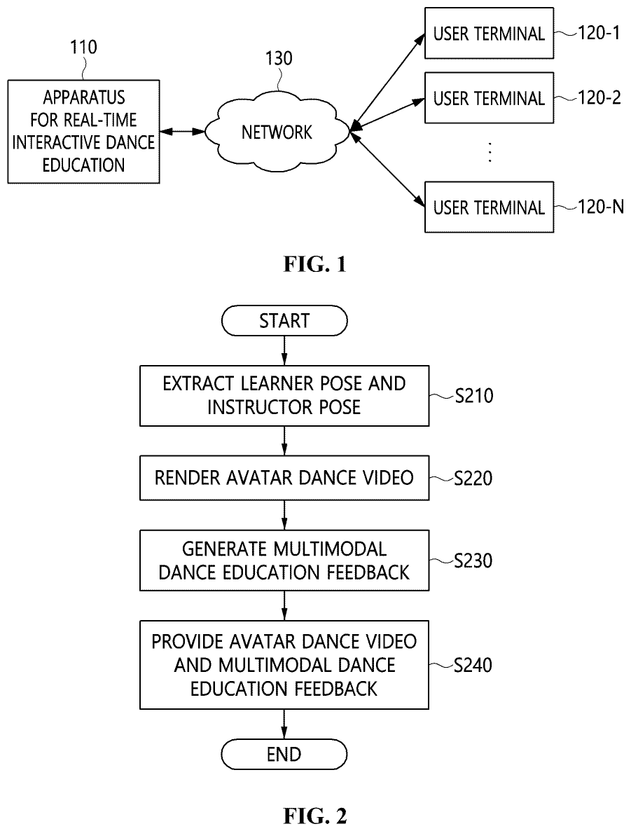

FIG. 1 is a view illustrating a real-time interactive dance education system using an avatar according to an embodiment of the present disclosure.

Referring to FIG. 1, the real-time interactive dance education system using an avatar according to an embodiment of the present disclosure includes an apparatus 110 for real-time interactive dance education, user terminals 120-1 to 120-N, and a network 130.

The apparatus 110 for real-time interactive dance education extracts a learner pose and an instructor pose from a dance video containing multiple dance learners and an instructional dance video, respectively.

Here, the learner pose and the instructor pose may correspond to time-series data extracted in real time in the form of 2D and 3D skeleton data.

Here, the instructional dance video may correspond to a dance video of a professional dancer for a dance section identical to the dance video.

Also, the apparatus 110 for real-time interactive dance education renders an avatar dance video based on the extracted pose of a main learner among the multiple dance learners.

Here, the avatar dance video may include a main character avatar corresponding to the main learner, backup dancer avatars corresponding to surrounding learners that remain after excluding the main learner from the multiple dance learners, and a background environment.

Here, the main learner may be extracted from the dance video and visually rendered as the main character avatar, the remaining surrounding learners may be extracted from the dance video and visually rendered as the backup dancer avatars, and the background environment may be visually rendered.

Here, the dance learner located in the center of a frame of the dance video, among the multiple dance learners, may be extracted as the main learner.

Here, the avatar dance video may be generated in a 2D or 3D form.

Also, the apparatus 110 for real-time interactive dance education generates multimodal dance education feedback for the main learner based on an error between the learner pose and the instructor pose.

Here, the error may be quantified into a practical score numerically applicable to dance education, educational information related to each body part, time, and physical quantity may be extracted by inputting the learner pose and the instructor pose to a pretrained data-driven dance model, and multimodal dance education feedback that can be output through a multimodal display may be generated using the practical score and the educational information.

Here, the multimodal dance education feedback may include visual expression, auditory expression, and haptic expression.

Also, the apparatus 110 for real-time interactive dance education provides the main learner with the real-time multimodal dance education feedback synchronized to the avatar dance video.

Through the above-described system, dance education technology that allows an instructor who aims to teach dances to reflect dynamic changes of body parts required for dance learning in real time through an avatar in consideration of the temporal aspect of a dance may be provided.

Also, a dance education system based on multimodal interaction that encompasses vision and multiple sensations may be provided through an education system using avatars.

Also, a visual display that is configured with a main character and background characters may be provided by rendering a main learner and surrounding learners as avatars.

FIG. 2 is a flowchart illustrating a method for real-time interactive dance education using an avatar according to an embodiment of the present disclosure.

Referring to FIG. 2, in the method for real-time interactive dance education using an avatar according to an embodiment of the present disclosure, an apparatus for real-time interactive dance education extracts a learner pose and an instructor pose from a dance video containing multiple dance learners and an instructional dance video, respectively, at step S210.

Here, the learner pose and the instructor pose may correspond to time-series data extracted in real time in the form of 2D and 3D skeleton data.

Here, the instructional dance video may correspond to a dance video of a professional dancer for the same dance section as the dance video.

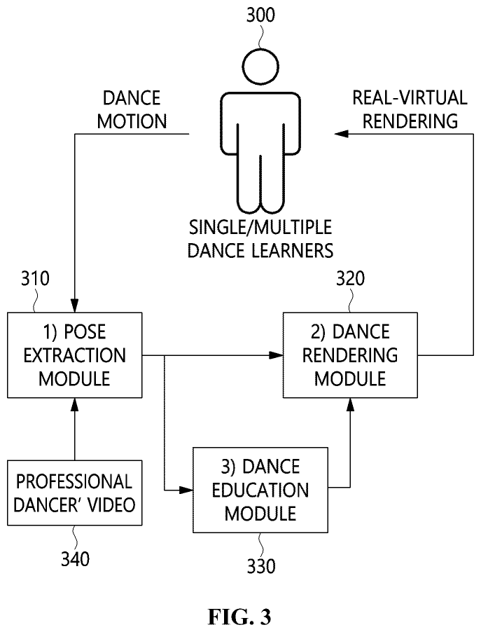

For example, referring to FIG. 3, the apparatus for real-time interactive dance education according to an embodiment of the present disclosure may be configured with a pose extraction module 310, a dance rendering module 320, and a dance education module 330.

According to FIG. 3, the apparatus for real-time interactive dance education may acquire dance motion of single or multiple dance learners 300 through a dance video and provide multimodal feedback thereon by rendering the same through a real-virtual environment. Here, the multimodal feedback may be feedback using five senses, such as sight, hearing, touch, and the like. Also, the apparatus for real-time interactive dance education may be used for dance education by receiving a professional dancer's video 340 along with the dance motion of the single or multiple dance learners 300, as illustrated in FIG. 3.

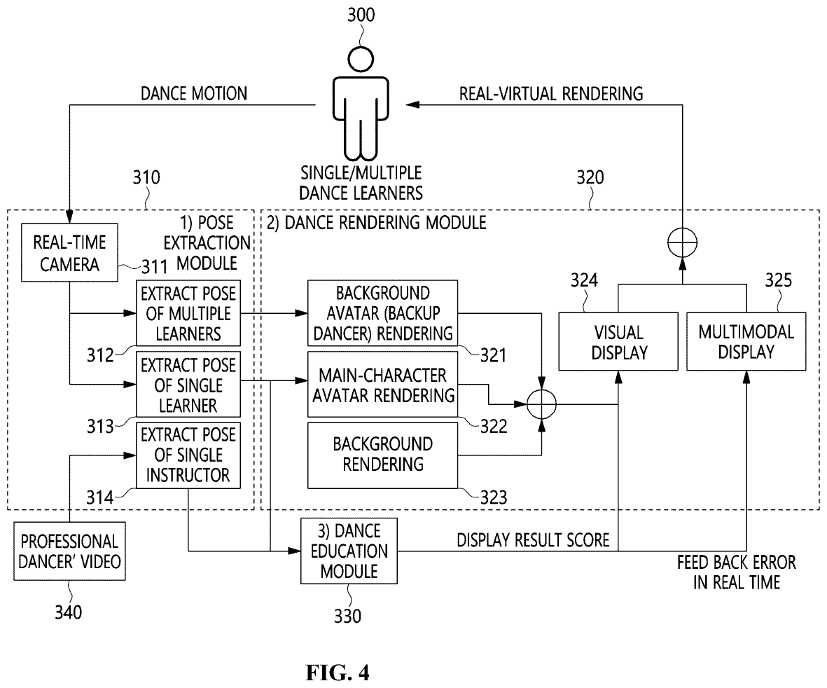

Hereinafter, the detailed structure of the pose extraction module 310 and the process of extracting the learner pose and the instructor pose will be described in detail with reference to FIG. 4.

According to FIG. 4, the pose extraction module 310 may acquire a dance video by capturing the dance motion of the single or multiple dance learners 300 using a recording device such as a real-time camera 311.

Here, among the single or multiple dance learners 310, a main leaner who is the dance learner located in the center of a frame of the dance video may be distinguished from the rest of the multiple learners.

Subsequently, the 2D and 3D poses of individual learners, which are identified using a multi-degree-of-freedom skeleton method, may be extracted in real time as a time series. For example, single learner pose extraction 313 for the main learner and multi-learner pose extraction 312 for the remaining leaners, excluding the main learner, may be performed.

Also, the pose extraction module 310 may extract a single instructor pose from the professional dancer's video 340 for dance education (single instructor pose extraction 314).

Here, the professional dancer's video 340 may correspond to the instructional dance video covered in the present disclosure, and may correspond to the dance video of a professional dancer for the same dance section as the dance video of the single or multiple dance learners 300.

Also, in the method for real-time interactive dance education using an avatar according to an embodiment of the present disclosure, the apparatus for real-time interactive dance education renders an avatar dance video based on the extracted pose of a main learner among the multiple dance learners.

Here, the avatar dance video may include a main character avatar corresponding to the main learner, backup dancer avatars corresponding to surrounding learners remaining after excluding the main learner from the multiple dance learners, and a background environment.

Here, the main learner may be extracted from the dance video and visually rendered as the main character avatar, the remaining surrounding learners may be extracted from the dance video and visually rendered as the backup dancer avatars, and the background environment may be visually rendered.

Here, the dance learner located in the center of a frame of the dance video, among the multiple dance learners, may be extracted as the main learner.

Here, the avatar dance video may be generated in a 2D or 3D form.

For example, referring to FIG. 3, the dance rendering module 320 of the apparatus for real-time interactive dance education may perform real-virtual rendering using the data transferred from the pose extraction module 310 and the dance education module 330.

Hereinafter, the detailed structure of the dance rendering module 320 and the process of generating an avatar dance video will be described in detail with reference to FIG. 4.

According to FIG. 4, the respective poses extracted by the pose extraction module 310 may be transferred to the dance rendering module 320.

Here, because the main learner who is actually educated for a dance or performs dance learning is usually located in the center of a frame of the dance video, the dance rendering module 320 may perform main-character avatar rendering 322 for the main learner for transformation into a 3D avatar.

Also, the remaining surrounding learners around the main learner may be visually rendered as backup dancer avatars in a 2D or 3D form through background avatar rendering or backup dancer rendering 321.

Here, whether to represent the remaining surrounding learners as 2D avatars or 3D avatars is determined depending on the dance environment, whereby the main character avatar may be clearly distinguished from the backup dancer avatars.

Also, the background environment suitable for expressing the dance environment in which the main character avatar and the backup dancer avatars are dancing may be visually rendered in 2D or 3D.

That is, in the present disclosure, when a dance video is rendered in real time with 3D avatars, a main character, surrounding characters, and a background may be rendered separately.

Then, a single avatar dance video may be generated by combining the main character avatar, the backup dancer avatars, and the background environment, which are rendered separately as described above.

Also, the dance rendering module 320 may render feedback information for dance education and provide the same to the main learner based on a visual display 324 and a multimodal display 325.

Also, in the method for real-time interactive dance education using an avatar according to an embodiment of the present disclosure, the apparatus for real-time interactive dance education generates multimodal dance education feedback for the main learner based on an error between the learner pose and the instructor pose.

Here, the error may be quantified into a practical score numerically applicable to dance education, educational information related to each body part, time, and physical quantity may be extracted by inputting the learner pose and the instructor pose to a pretrained data-driven dance model, and the multimodal dance education feedback that can be output through a multimodal display may be generated using the practical score and the educational information.

Here, the multimodal dance education feedback may include visual expression, auditory expression, and haptic expression.

For example, referring to FIG. 3, the dance education module 330 of the apparatus for real-time interactive dance education may provide information required for dance education by using the learner pose and the instructor pose, which are received from the pose extraction module 310.

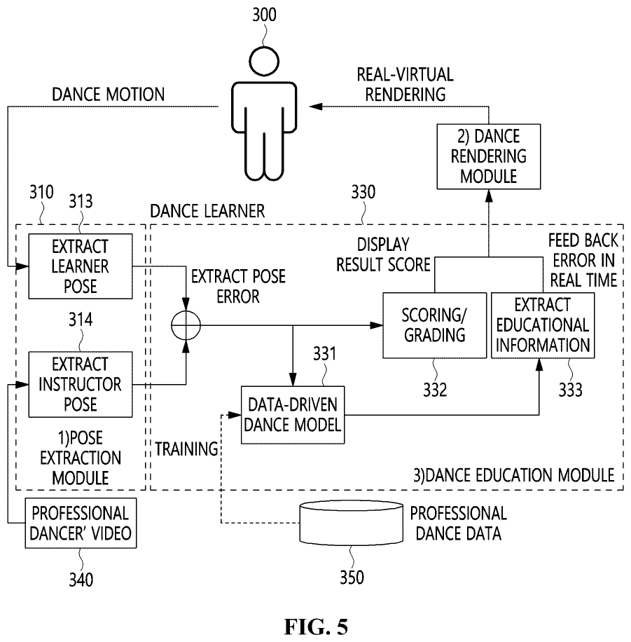

Hereinafter, the detailed structure of the dance education module 330 and the process of generating real time multimodal dance education feedback will be described in detail with reference to FIG. 5.

According to FIG. 5, the learner pose of the chosen main learner and the instructor pose of a professional dancer, both extracted by the pose extraction module 310, may be transferred to the dance education module 330.

Here, the core of the dance education module 330 is a data-driven dance model 331, and the data-driven dance model 331 may serve to store and provide professional dance data 350 related to dance education of professional dancers.

For example, when the learner pose and the instructor pose received from the pose extraction module 310 are transferred to the data-driven dance model 331, the data-driven dance model 331 may extract 2D and 3D errors for each of the learner pose and the instructor pose and quantify the same into scores (332) so as to be used for education.

Here, the data-driven dance model 331 may be a model that is pretrained based on the professional dance data 350.

Also, the data-driven dance model 331 may extract educational information related to each body part, time, and physical quantity (333) and provide the same to be fed back in real time by reflecting the extracted educational information to the error or current performance (performance-based).

Also, in the method for real-time interactive dance education using an avatar according to an embodiment of the present disclosure, the apparatus for real-time interactive dance education provides the main learner with the real-time multimodal dance education feedback synchronized to the avatar dance video.

Referring to FIG. 5, the practical score and the educational information may be provided to the dance rendering module 320 through the dance education module 330 to be fed back in a form suitable for the main learner.

For example, the multimodal dance education feedback may include visual expression using encoded colors, vector expressions, facial expressions of avatars, etc., auditory expression that triggers an alarm for a large error, and haptic expression that uses vibration or pressure to stimulate a specific part of a user's body.

Also, referring to FIG. 4, the dance rendering module 320 may synchronize the avatar dance video provided through the visual display 324 and the multimodal dance education feedback provided through the multimodal display 325 and provide the same to the main learner.

Through the above-described method for real-time interactive dance education using an avatar, dance education technology that allows an instructor who aims to teach dances to reflect dynamic changes of body parts required for dance learning in real time through an avatar in consideration of the temporal aspect of a dance may be provided.

Also, a dance education system based on multimodal interaction that encompasses vision and multiple sensations may be provided through an education system using avatars.

Also, a visual display that is configured with a main character and background characters may be provided by rendering a main learner and surrounding learners as avatars.

Also, motion information is received in real time through equipment such as a camera or the like and represented as a 3D avatar, whereby feedback for education may be delivered in real time.

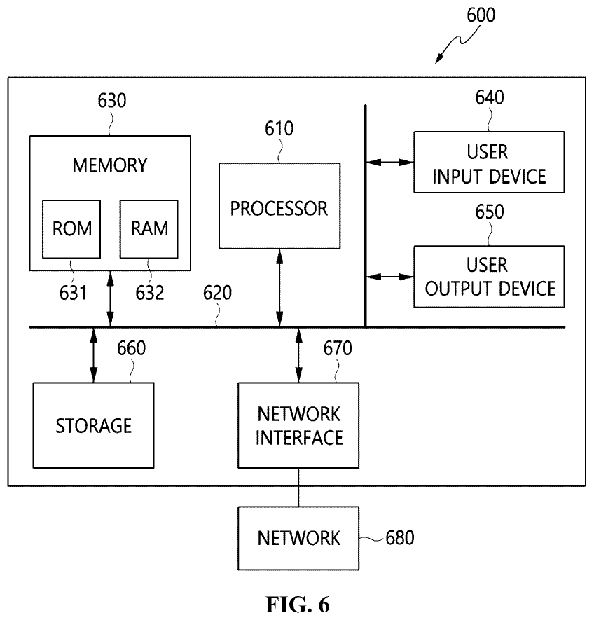

FIG. 6 is a block diagram illustrating an apparatus for real-time interactive dance education using an avatar according to an embodiment of the present disclosure.

Referring to FIG. 6, the apparatus for real-time interactive dance education using an avatar according to an embodiment of the present disclosure may be implemented in a computer system including a computer-readable recording medium. As illustrated in FIG. 6, the computer system 600 may include one or more processors 610, memory 630, a user input device 640, a user output device 650, and storage 660, which communicate with each other via a bus 620. Also, the computer system 600 may further include a network interface 670 connected to a network 680. The processor 610 may be a central processing unit or a semiconductor device for executing processing instructions stored in the memory 630 or the storage 660. The memory 630 and the storage 660 may be any of various types of volatile or nonvolatile storage media. For example, the memory may include ROM 631 or RAM 632.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

The processor 610 extracts a learner pose and an instructor pose from a dance video containing multiple dance learners and an instructional dance video, respectively.

Here, the learner pose and the instructor pose may correspond to time-series data extracted in real time in the form of 2D and 3D skeleton data.

Here, the instructional dance video may correspond to a dance video of a professional dancer for the same dance section as the dance video.

Also, the processor 610 renders an avatar dance video based on the extracted pose of a main learner among the multiple dance learners.

Here, the avatar dance video may include a main character avatar corresponding to the main learner, backup dancer avatars corresponding to surrounding learners that remain after excluding the main learner from the multiple dance learners, and a background environment.

Here, the main learner may be extracted from the dance video and visually rendered as the main character avatar, the remaining surrounding learners may be extracted from the dance video and visually rendered as the backup dancer avatars, and the background environment may be visually rendered.

Here, the dance learner located in the center of a frame of the dance video, among the multiple dance learners, may be extracted as the main learner.

Here, the avatar dance video may be generated in a 2D or 3D form.

Also, the processor 610 generates multimodal dance education feedback for the main learner based on an error between the learner pose and the instructor pose.

Here, the error may be quantified into a practical score numerically applicable to dance education, educational information related to each body part, time, and physical quantity may be extracted by inputting the learner pose and the instructor pose to a pretrained data-driven dance model through the user input device 640, such as the real-time camera 311, and the multimodal dance education feedback that can be output to the user output device 650, such as the visual display 324, the multimodal display 325, or the like, may be generated using the practical score and the educational information.

Here, the multimodal dance education feedback may include visual expression, auditory expression, and haptic expression.

Also, the processor 610 provides the main learner with the real-time multimodal dance education feedback synchronized to the avatar dance video.

The memory 630 stores the dance video and the instructional dance video.

Also, the memory 630 stores various kinds of information generated during the above-described process of real-time interactive dance education using an avatar according to an embodiment.

According to an embodiment, the memory 630 may be separate from the apparatus for real-time interactive dance education using an avatar to support the function for real-time interactive dance education using an avatar. Here, the memory 630 may operate as separate mass storage, and may include a control function for performing operations.

Meanwhile, the apparatus for real-time interactive dance education using an avatar includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Using the above-described apparatus for real-time interactive dance education using an avatar, dance education technology that allows an instructor who aims to teach dances to reflect dynamic changes of body parts required for dance learning in real time through an avatar in consideration of the temporal aspect of a dance may be provided.

Also, a dance education system based on multimodal interaction that encompasses vision and multiple sensations may be provided through an education system using avatars.

Also, a visual display that is configured with a main character and background characters may be provided by rendering a main learner and surrounding learners as avatars.

According to the present disclosure, dance education technology that allows an instructor who aims to teach dances to reflect dynamic changes of body parts required for dance learning in real time through an avatar in consideration of the temporal aspect of a dance may be provided.

Also, the present disclosure may provide a dance education system based on multimodal interaction that encompasses vision and multiple sensations through an education system using avatars.

Also, the present disclosure may provide a visual display configured with a main character and background characters by rendering a main learner and surrounding learners as avatars.

As described above, the method for real-time interactive dance education using an avatar and the apparatus therefor according to the present disclosure are not limitedly applied to the configurations and operations of the above-described embodiments, but all or some of the embodiments may be selectively combined and configured, so the embodiments may be modified in various ways.

What is claimed is:

1. A method for real-time interactive dance education, performed by an apparatus for real-time interactive dance education, comprising:
extracting a learner pose and an instructor pose from a dance video containing multiple dance learners and an instructional dance video, respectively;
rendering an avatar dance video based on the extracted pose of a main learner among the multiple dance learners;
generating real-time multimodal dance education feedback for the main learner based on an error between the learner pose and the instructor pose; and
providing the real-time multimodal dance education feedback synchronized to the avatar dance video.

2. The method of claim 1, wherein the learner pose and the instructor pose correspond to time-series data extracted in real time in a form of 2D and 3D skeleton data.

3. The method of claim 2, wherein generating the multimodal dance education feedback includes
quantifying the error into a practical score numerically applicable to dance education;
extracting educational information related to each body part, time, and physical quantity by inputting the learner pose and the instructor pose to a pretrained data-driven dance model; and
generating the multimodal dance education feedback capable of being output through a multimodal display using the practical score and the educational information.

4. The method of claim 1, wherein the multimodal dance education feedback includes visual expression, auditory expression, and haptic expression.

5. The method of claim 1, wherein the avatar dance video includes a main character avatar corresponding to the main learner, backup dancer avatars corresponding to surrounding learners that remain after excluding the main learner from the multiple dance learners, and a background environment.

6. The method of claim 5, wherein rendering the avatar dance video includes
visually rendering the main learner as the main character avatar after extracting the main learner from the dance video;
visually rendering the remaining surrounding learners as the backup dancer avatars after extracting the remaining surrounding learners from the dance video; and
visually rendering the background environment.

7. The method of claim 6, wherein visually rendering the main learner comprises extracting a dance learner located in a center in a frame of the dance video, among the multiple dance learners, as the main learner.

8. The method of claim 1, wherein the instructional dance video corresponds to a dance video of a professional dancer for a dance section identical to the dance video.

9. The method of claim 1, wherein the avatar dance video is generated in a 2D or 3D form.

10. An apparatus for real-time interactive dance education, comprising:
a processor for extracting a learner pose and an instructor pose from a dance video containing multiple dance learners and an instructional dance video, respectively, rendering an avatar dance video based on the extracted pose of a main learner among the multiple dance learners, generating real-time multimodal dance education feedback for the main learner based on an error between the learner pose and the instructor pose, and providing the main learner with the real-time multimodal dance education feedback synchronized to the avatar dance video; and
memory for storing the dance video and the instructional dance video.

11. The apparatus of claim 10, wherein the learner pose and the instructor pose correspond to time-series data extracted in real time in a form of 2D and 3D skeleton data.

12. The apparatus of claim 11, wherein the processor quantifies the error into a practical score numerically applicable to dance education, extracts educational information related to each body part, time, and physical quantity by inputting the learner pose and the instructor pose to a pretrained data-driven dance model, and generates the multimodal dance education feedback capable of being output through a multimodal display using the practical score and the educational information.

13. The apparatus of claim 10, wherein the multimodal dance education feedback includes visual expression, auditory expression, and haptic expression.

14. The apparatus of claim 10, wherein the avatar dance video includes a main character avatar corresponding to the main learner, backup dancer avatars corresponding to surrounding learners that remain after excluding the main learner from the multiple dance learners, and a background environment.

15. The apparatus of claim 14, wherein the processor visually renders the main learner as the main character avatar after extracting the main learner from the dance video, visually renders the remaining surrounding learners as the backup dancer avatars after extracting the remaining surrounding learners from the dance video, and visually renders the background environment.

16. The apparatus of claim 15, wherein the processor extracts a dance learner located in a center in a frame of the dance video, among the multiple dance learners, as the main learner.

17. The apparatus of claim 10, wherein the instructional dance video corresponds to a dance video of a professional dancer for a dance section identical to the dance video.

18. The apparatus of claim 10, wherein the avatar dance video is generated in a 2D or 3D form.
